(19) United States
(12) Patent Application Publication
(10) Pub. No.: US 2009/0168475 A1
(43) Pub. Date: Jul. 2, 2009

(54) CONVERTER POWER SUPPLY CIRCUIT AND CONVERTER POWER SUPPLY DRIVING METHOD

(75) Inventor: Hideki Hirosawa, Fujioka-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/204,714

(22) Filed: Sep. 4, 2008

(30) Foreign Application Priority Data
Dec. 26, 2007 (JP) 2007-335134

(51) Int. Cl. H02M 7/217

(52) U.S. Cl. 363/84

(57) ABSTRACT

A converter power supply circuit 100 includes SW_Q1 and SW_Q2 which switch a voltage inputted from an alternating power supply 101 via a full-wave rectifier 102 and a low-pass filter 103, by drive signals applied thereto and generate an output signal; an output current detecting unit 114 which detects a current value of the output signal to a load 113; a memory 118 in which prescribed values for changing the switching operation modes of the SW_Q1 and SW_Q2 are set; and a drive circuit 116 and a control circuit 115 which detect switching currents of the SW_Q1 and SW_Q2 and continuously change the operation state of the SW_Q1 and SW_Q2 from a high power consumption state to a low power consumption state according to a comparison result of the values of the detected currents to the prescribed values in the memory 118.

### CROSS-REFERENCE TO RELATED APPLICATIONS

This application is based upon and claims the benefit of priority from the prior Japanese Patent Application No. 2007-335134, filed on Dec. 26, 2007 the entire contents of which are incorporated herein by reference.

### BACKGROUND

1. Field of the Invention

The present invention relates, for example, to a converter power supply circuit and a converter power supply driving method.

2. Description of the Related Art

In recent years, electronic devices such as a liquid crystal television set provided with, for example, a reserved recording function have a power saving mode from the trend of resource saving.

Conventionally, as a converter power supply circuit having a multiphase circuit such as a power factor correction converter (PFC), a converter power supply circuit capable of supplying a large power while suppressing occurrence of noise by switching, for example, four switching elements by drive signals with a constant frequency and different phases from each other so that the terminal voltage of a smoothing capacitor exhibits a predetermined value has been proposed (see, for example, JP-A 2006-187140 (KOKAI)).

### SUMMARY

Usually, the converter power supply circuit having a multiphase circuit operates in a current continuous mode when the power consumption is high, and operates in a current discontinuous mode when the power consumption is low, but much noise is generated in the current continuous mode.

Therefore, in the above-described prior art, many multiphase circuits are provided to be able to provide large power in the current discontinuous mode, but its problem is that further improvement in power supply efficiency is hindered because two systems of four systems of the multiphase circuits are driven even when the power consumption is low.

The present invention has been developed to solve the problem and its object is to provide a converter power supply circuit having a multiphase circuit in which the power supply efficiency can be improved in a light load state in which not all of a plurality of systems need to be operated, and a converter power supply circuit driving method.

A converter power supply circuit according to an aspect of the present invention includes: a rectifier/smoothing unit which converts an alternating power supply into a direct-current power supply; a plurality of switching elements which are connected in parallel, to an output end of the rectifier/smoothing unit and switch by drive signals individually applied thereto to generate an output signal; a smoothing capacitor which smoothes the output signal of the plurality of switching elements and supplies a smoothed signal to a load; a switching current detecting unit which detects switching currents of the individual switching elements; an output current detecting unit which detects a current of the output signal; a memory in which threshold values for changing switching operations of the switching elements are set; and a control unit which applies drive signals to the switching elements to continuously change an operation state thereof from a high power consumption state in which the plurality of switching elements are fully driven to a low power consumption state in which one of the plurality of switching elements is intermittently driven at a predetermined cycle, according to a comparison result of values of the currents detected by the output current detecting unit and the switching current detecting unit to the threshold values in the memory.

A converter power supply circuit driving method according to an aspect of the present invention includes: converting an alternating power supply into a direct-current power supply by a rectifier/smoothing unit; individually applying drive signals to a plurality of switching elements which are connected in parallel, to an output end of the rectifier/smoothing unit to alternately switch the switching elements to generate an output signal; smoothing the output signal of the plurality of switching elements by a smoothing capacitor and supplying a smoothed signal to a load; detecting switching currents of the individual switching elements by a switching current detecting unit; detecting a current of the output signal by an output current detecting unit; and comparing values of the currents detected by the output current detecting unit and the switching current detecting unit to threshold values for changing switching operations stored in advance in a memory, and applying the drive signals to the switching elements to continuously change an operation state thereof from a high power consumption state in which the plurality of switching elements are fully driven to a low power consumption state in which one of the plurality of switching elements is intermittently driven at a predetermined cycle, according to a result of the comparison.

This can improve the power supply efficiency in a light load state in which not all of a plurality of systems need to be operated in a converter power supply circuit having a multiphase circuit.

### BRIEF DESCRIPTION OF THE DRAWINGS

FIG. 1 is a diagram showing a configuration of a converter power supply circuit of a first embodiment.

FIG. 2 is a diagram showing the output signal in a mode “0” among operations modes of the converter power supply circuit.

FIG. 3 is a diagram showing the output signal in a mode “1” among the operations modes of the converter power supply circuit.

FIG. 4 is a diagram showing the output signal in a mode “2” among the operations modes of the converter power supply circuit.

FIG. 5 is a diagram showing the output signal in a mode “3” among the operations modes of the converter power supply circuit.

FIG. 6 is a diagram showing the output signal in a mode “4” among the operations modes of the converter power supply circuit.

FIG. 7 is a diagram showing the output signal in a mode “5” among the operations modes of the converter power supply circuit.

FIG. 8 is a flowchart showing the operation of the converter power supply circuit.

FIG. 9 is a diagram indicating the relationship between the oscillation frequency and the output signal.

FIG. 10 is a diagram showing a configuration of a converter power supply circuit of a second embodiment.

### DETAILED DESCRIPTION

Hereinafter, embodiments of the present invention will be described in detail with reference to the drawings.

### First Embodiment

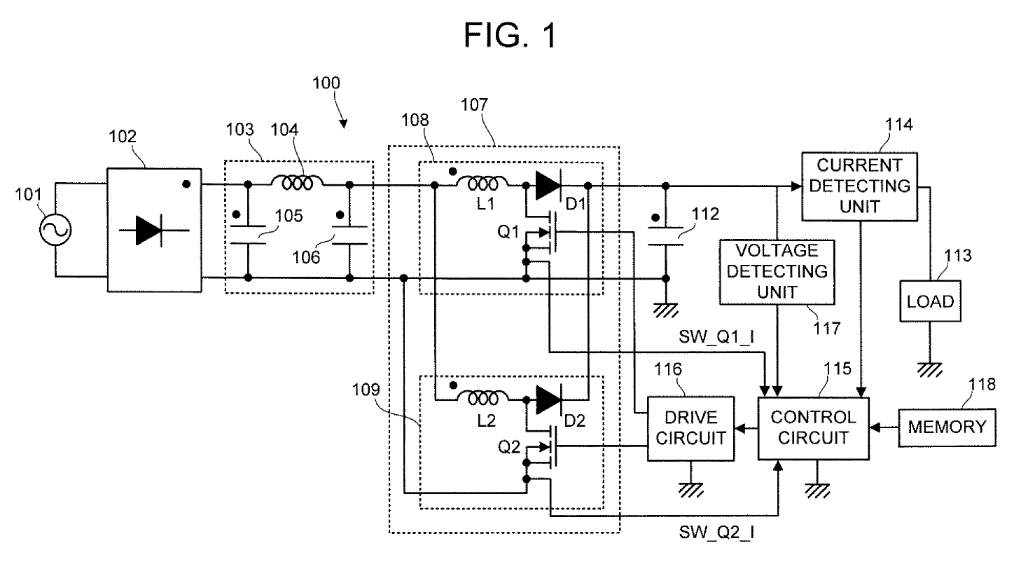

As shown in FIG. 1, a converter power supply circuit 100 of the first embodiment includes a full-wave rectifier 102 which rectifies an alternating voltage inputted from an alternating power supply 101 being a power source, and a low-pass filter 103 which smoothes the output of the full-wave rectifier 102.

The low-pass filter 103 is composed of a choke coil 104 connected to the output end of the full-wave rectifier 102 in series, and a capacitors 105 and 106 connected between both ends of the choke coil 104 and reference potential point (ground point) respectively.

The low-pass filter 103 is connected to a chopper circuit group 107. The chopper circuit group 107 is composed of a plurality of chopper circuits which are, for example, connected in parallel, for example, two chopper circuits 108 and 109. The chopper circuits 108 and 109 are configured as the same circuit.

The full-wave rectifier 102 and the low-pass filter 103 form a rectifier/smoothing unit which converts the alternating voltage inputted from the alternating power supply 101 into a direct-current voltage.

A system in which power is supplied from the chopper circuit 108 to a load 113 is referred to as a first system.

A system in which power is supplied from the chopper circuit 109 to the load 113 is referred to as a second system.

The chopper circuits 108 and 109 have respective series connections of choke coils L1 and L2 connected to the output end of the low-pass filter 103 in series and forward diodes D1 and D2 having anodes connected to the choke coils L1 and L2, and switching transistors Q1 and Q2 (hereinafter referred to as “SW_Q1” and “SW_Q2”) having drains-sources connected between connection points of the choke coils L1 and L2 and the diodes D1 and D2 and the reference potential point.

In this case, the reference potential point is grounded. The SW_Q1 and SW_Q2 are, for example, MOS field effect transistors (MOS-FETs) or the like.

The SW_Q1 and SW_Q2 are connected in parallel with each other, to the output end of the low-pass filter 103.

The SW_Q1 and SW_Q2 are a plurality of switching elements which switch by drive signals individually applied from a drive circuit 116 and generate an output signal.

The cathodes of the diodes D1 and D2 of the chopper circuits 108 and 109 are connected to a parallel circuit composed of a smoothing capacitor 112 and the load 113. The smoothing capacitor 112 smoothes the output signal of the plurality of SW_Q1 and SW_Q2 and supplies the smoothed signal to the load 113.

To one end of the smoothing capacitor 112, a voltage detecting unit 117 is connected which detects the terminal voltage of the smoothing capacitor 112.

The voltage detecting unit 117 detects the terminal voltage of the smoothing capacitor 112.

The voltage detecting unit 117 notifies (supplies) a control circuit 115 of (with) the terminal voltage as the detection result.

Between the smoothing capacitor 112 and the load 113, a current detecting unit 114 is connected.

The current detecting unit 114 functions as an output current detecting unit which detects the current flowing to the load 113 (hereinafter, referred to as an “output current”).

To the source terminals of the SW_Q1 and SW_Q2, the control circuit 115 is connected, so that the currents flowing through the SW_Q1 and SW_Q2 (hereinafter, referred to as “SW currents”) are detected by the control circuit 115.

In other words, the control circuit 115 functions as a switching current detecting unit which detects the switching currents of the individual SW_Q1 and SW_Q2.

Note that the SW current of the SW_Q1 is called an SW_Q1_I as a first switching current, and the SW current of the SW_Q2 is called as an SW_Q2_I as a second switching current.

Further, a memory 118 is connected to the control circuit 115. In the memory 118, a plurality of prescribed values are set as threshold values for changing the switching operations of the SW_Q1 and SW_Q2.

For the plurality of prescribed values, different values corresponding to the operation modes are set.

The control circuit 115 compares the terminal voltage detected by the voltage detecting unit 117, the output current detected by the current detecting unit 114, and the SW_Q1_I and SW_Q2_I detected from the SW_Q1 and SW_Q2 to the corresponding prescribed values previously set in the memory 118 to determine whether the detected current is larger or smaller than an adequate current value, and controls the drive circuit 116 based on the determination result to drive the SWs (SW_Q1 and SW_Q2), that is, to cause the drive circuit 116 to perform switching operation.

More specifically, the control circuit 115 and the drive circuit 116 functions as a control unit which detects the switching current from the terminal voltage detected by the voltage detecting unit 117, compares the value of the detected switching current, the value of the output current detected by the current detecting unit 114 and the threshold values in the memory 118, and applies drive signals to the SW_Q1 and SW_Q2 so as to continuously change the operation state thereof according to the comparison result from a high power consumption state in which the plurality of SW_Q1 and SW_Q2 are fully driven to a low power consumption state in which only one of the plurality of switching elements is intermittently driven at a predetermined cycle (time period).

As described above, the memory 118 stores the current prescribed values being threshold values for performing determination of the driving mode change through comparison with the currents detected by the detecting units.

The current proscribed values include an output current prescribed value for comparison with the output current indicating the power consumption on the side of the load 113, SW current prescribed values for comparison to the currents for every pulse flowing through the SW_Q1 and SW_Q2 and so on.

The SW current proscribed values include a plurality of prescribed values having different values, for example, a first SW current prescribed value, a second SW current prescribed value, and a third SW current prescribed value.

The values are smaller in order from the first SW current prescribed value to the third SW current prescribed value.

More specifically, the first SW current prescribed value is a larger value, and the third SW current prescribed value is a smaller value.

The second SW current prescribed value is a value between the first SW current prescribed value and the third SW current prescribed value.

The drive circuit 116 outputs the drive signals which turn on/off the SW_Q1 and SW_Q2 of the chopper circuits 108 and 109.

Each of the SW_Q1 and SW_Q2 is subjected to ON/OFF control by the drive circuit 116 at the timing according to the detected result of the voltage detecting unit 117 so that its operation is switched.

The control circuit 115 varies power supply by making the cycles (time periods) for alternate operation of the two SW_Q1 and SW_Q2 the same and changing their respective drive periods, in the high power consumption state to the middle power consumption state.

The drive signals outputted from the drive circuit 116 to the SW_Q1 and SW_Q2 are signals which are the same in frequency and different only in phase.

The SW_Q1 and SW_Q2 are driven by input of the drive signals which are the same in frequency and different only in phase so that their ON-periods are not overlapped.

If the terminal voltage of the smoothing capacitor 112 is low as a result of the voltage detection, the drive circuit 115 increasingly frequently drives the chopper circuits 108 and 109 stepwise by changing the operation mode.

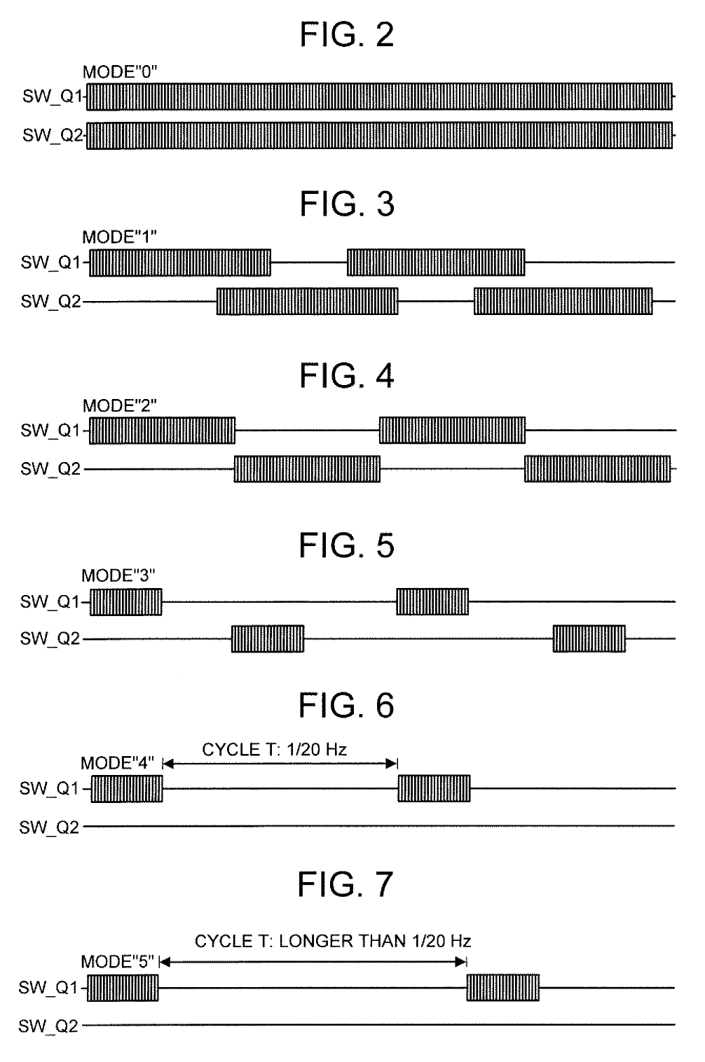

In the most fully driving state, the control circuit 115 changes (sets) the operation state to a mode “0” as shown in FIG. 2 to drive the SW_Q1 and SW_Q2 of all systems so that all of the plurality of chopper circuits 108 and 109 operate.

Thereafter, when the terminal voltage of the smoothing capacitor 112 is increased, the control circuit 115 gradually reduces the drive amounts of the chopper circuits 108 and 109 to thereby bring the operation state, for example, to a mode “1” as shown in FIG. 3.

In the more “1, the two chopper circuits 108 and 109 are alternately intermittently operated so that their operations partially overlap.

Further, when the terminal voltage of the smoothing capacitor 112 is kept at the constant value, the operation mode is changed in order from a mode “2” to a mode “3.”

In theses modes, as shown in FIG. 4 and FIG. 5, the switching interval between the chopper circuits 108 and 109 is gradually lengthened in order from the mode “2” to the mode “3.”

Thereafter, when the terminal voltage of the smoothing capacitor 112 is kept at the constant value, the operation state is brought to a mode “4.”

As shown in FIG. 6, in the mode “4,” only one chopper circuit (the chopper circuit 108 or the chopper circuit 109) is operated.

In this example, the SW_Q1 of the chopper circuit 108 is operated, while the operation of the SW_Q2 of the chopper circuit 109 is stopped.

Further, when the terminal voltage of the smoothing capacitor 112 is kept at the constant value, the operation state is brought to a mode “5” because a decrease in power supply ability causes no problem.

As shown in FIG. 7, the one operated chopper circuit is operated with a cycle (time period) T of driving the chopper circuit changed to a cycle (time period) T1 in the mode “5.”

The cycle (time period) T1 causes switching noise of drive/stop to occur, and therefore the direction to change the time period here is a direction to decrease the frequency to 20 Hz or less, such as 15 Hz, 10 Hz or the like.

This changes the frequency to the direction outside the audible range for human beings to make uncomfortable noise inaudible.

The individual circuits themselves of the chopper circuits 108 and 109 are well-known circuits and therefore description thereof will be omitted. Briefly explaining, the chopper circuits 108 and 109 operate such that the energies accumulated in the choke coils L1 and L2 during the ON periods of the SW_Q1 and SW_Q2 are superposed on the input voltages, and the resulting voltage is supplied to the smoothing capacitor 112 when the SW_Q1 and SW_Q2 are turned off.

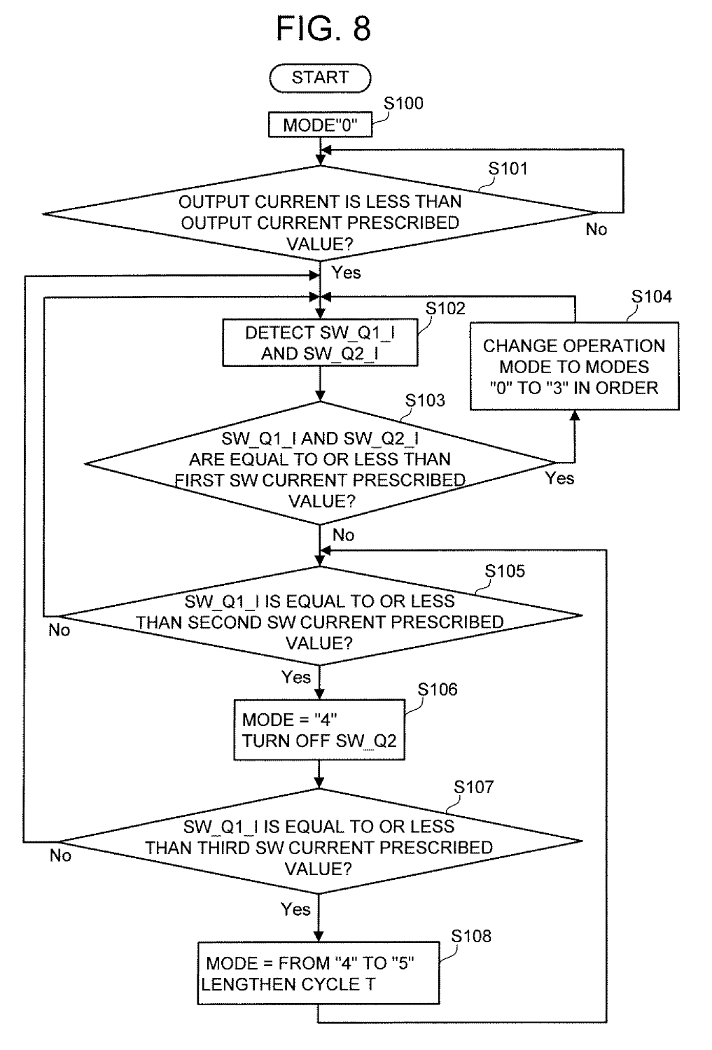

Hereinafter, the operation of the converter power supply circuit of the first embodiment will be described with reference to FIG. 8.

In the case of the converter power supply circuit of the first embodiment, when the AC power supply is inputted from the alternating power supply 101, the control circuit 115 sets the operation mode of the circuit to the mode “0” (Step S100) to control the drive circuit 11 to fully operate the two systems.

This causes the SW_Q1 and SW_Q2 of the chopper circuits 108 and 109 in which the two systems continuously operate to output the output signal as shown in FIG. 2.

The operations of the chopper circuits 108 and 109 generate the terminal voltage of the smoothing capacitor 112, and the output signal is supplied to the load 113 via the current detecting unit 114.

At this moment, the control circuit 115 is notified of the output current detected by the current detecting unit 114.

The control circuit 115 notified of the output current reads the output current prescribed value from the memory 118 and compares it with the notified output current(Step S101).

As a result of the comparison, when the detected output current is less than the output current prescribed value, the control circuit 115 detects the SW_Q1_I that is the current of the SW_Q1 and the SW_Q2_I that is the current of the SW_Q2 (Step S102).

After detection of the SW_Q1_I and SW_Q2_I, the control circuit 115 reads the first SW current prescribed value from the memory 118 and compares it with the values of the detected currents.

As a result of the comparison, when the values of the SW_Q1_I and SW_Q2 I are equal to or less than the first SW current prescribed value (Yes in Step S103), the control circuit 115 brings the operation mode to the mode “1” that is lower than the mode “0” by one level (Step S104) and then detects the SW_Q1_I and SW_Q2_I (Step S102).

In other words, the operation mode is changed among the modes “0” to “3” (up/down) in order, so that the SW_Q1_I and SW_Q2_I do not indicate the prescribed value or less.

On the other hand, as a result of the comparison, when the values of the SW_Q1_I and SW_Q2_I are not equal to or less than the first SW current prescribed value (No in Step S103), the control circuit 115 subsequently determines whether or not the detected SW_Q1_I is equal to or less than the second SW current prescribed value in the memory 118 (Step S105).

As a result of the comparison, when the SW_Q1_I is equal to or less than the second SW current prescribed value (Yes in S105), the control circuit 115 brings the operation mode to the mode “4” and turns off the SW_Q2 (Step S106).

As shown in FIG. 6, in the mode “4,” the cycle (time period) T being the drive interval is set to about 20 Hz that is the limit of the audible sound for the human beings.

After switching to the driving state only by the SW_Q1, the control circuit 115 compares the detected SW_Q1_I to the third SW current prescribed value in the memory 118 and determines whether or not the SW_Q1_I is equal to or less than the third SW current prescribed value in the memory 118 (Step S107).

As a result of the comparison, when the detected SW_Q1_I is equal to or less than the third SW current prescribed value (Yes in S107), the control circuit 115 changes the operation mode from the mode “4” to the mode “5” to lengthen the cycle (time period) T being the drive interval of the SW_Q1 (Step S108).

Repeating the above processing makes it possible to operate the minimum required chopper circuit(s) 108 and/or 109 according to the variation of the load 113 to supply required power.

According to the converter power supply circuit 100 of the first embodiment, the following effects are presented.

Specifically, in a light load state in which not all of the two systems need to be operated in a multiphase switching power supply using the plurality of chopper circuits 108 and 109 (power factor correction converter), the modes “4” and “5” are carried out to stop the chopper circuit 109 on one side, so that the switching loss can be reduced.

More specifically, in a state of an extremely light load in which very little power is consumed such as a standby state among light load states, only one system is operated, so that the switching loss can be reduced.

Note that if the switching interval between the two systems, or the switching interval or the operation/stop cycle (time period) during the drive of only one system is too short, the switching frequency falls within the audible range (20 Hz to 20000 Hz) and can cause the whining sound.

In such a case, by setting the cycle (time period) T being the switching interval longer than 1/20 Hz (0.05 sec.) by the timing setting by the control circuit 115, the influence of the switching noise sensed by the human beings can be eliminated.

Note that the timing setting is performed by setting, for example, of a time constant or a circuit constant of a counter circuit.

Besides, in the case where MOS-FETs (metal oxide semiconductor field effect transistors) are used for the switching elements such as the SW_Q1 and SW_Q2, the MOS-FETs have properties of increasing in on-resistance with an increase in temperature.

In such a case, by temporarily turning off only one system as in this embodiment, the operation temperature of the MOS-FET can be suppressed in the subsequent operation state as compared to the case where two systems are continuously operated as in the prior art.

This can reduce the loss to improve the power supply efficiency.

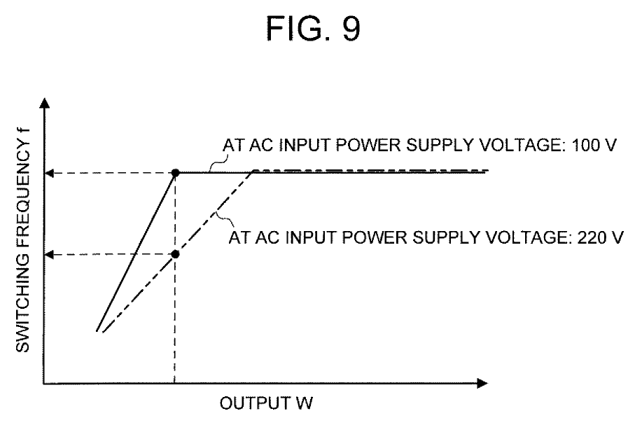

Note that as the application example of the above-described first embodiment, in order to output the same power, the switching frequency can be decreased by 220 V than by 100 V as shown in FIG. 9 in comparison between the output signal (output power) when the AC input power supply voltage is, for example, 100 V and the output signal (output power) when the AC input power supply voltage is 220 V.

Further, it can be said that the output signal and the switching frequency are in a proportional relationship until reaching the saturation state.

Hence, the switching frequency is made variable according to the value of the AC input power supply voltage.

In addition to the above, the control circuit 115 may vary the oscillation frequencies (drive frequencies) of the plurality of SW_Q1 and SW_Q2 in the control process from the high power consumption state in which the plurality of SW_Q1 and SW_Q2 are fully driven to the low power consumption state.

For example, when alternately turning on/off the two systems, the control circuit 115 increases the oscillation frequencies (drive frequencies), for example, to 80 KHz during the large power consumption as in the mode “0.”

The oscillation frequencies (drive frequencies) are decreased, for example, to 50 KHz during the middle power consumption as in the modes “1” to “3.”

Further, the oscillation frequencies (drive frequencies) are dropped (decreased), for example, to 30 KHz during the light power consumption as in the modes “4” and “5.”

In other words, the switching frequencies of the chopper circuits 108 and 109 themselves are continuously varied according to the supply state of the output signal, whereby the switching loss can be reduced, in particular, during the low load in which the loss increases.

### Second Embodiment

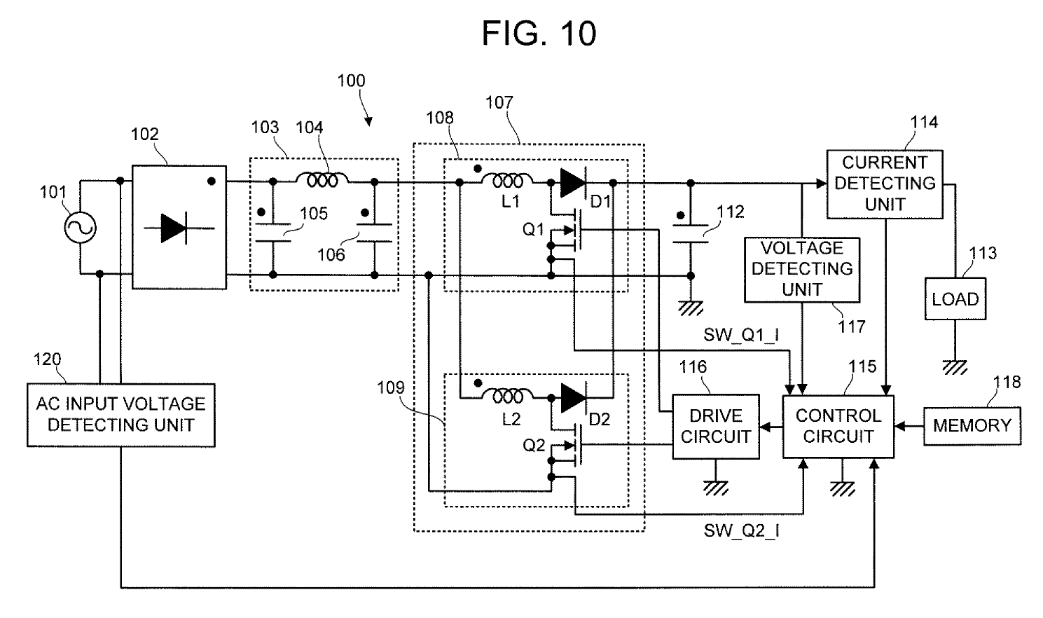

Next, a second embodiment will be described with reference to FIG. 10.

Note that the same numbers and symbols are given to the same configuration as in the first embodiment, and description thereof will be omitted in description of the second embodiment.

As shown in FIG. 10, the converter power supply circuit 100 of the second embodiment includes an AC input voltage detecting unit 120 which measures (detects) an alternating voltage (the value of the AC voltage) inputted from the alternating power supply 101.

The AC input voltage detecting unit 120 measures (detects) the alternating voltage (the AC voltage) of the alternating power supply 101 and notifies the control circuit 115 of the measured voltage value.

The control circuit 115 conducts control not to operate all of the chopper circuit 108 and the chopper circuit 109 because operation of the plurality of chopper circuits 108 and 109 is wasteful in a period when the AC voltage detected value (voltage value) notified from the AC input voltage detecting unit 120 reaches a value (0 V or a value close to 0 V) lower than an input voltage prescribed value (for example, about 10 V) which has been set in advance in the memory 118, during the operation in the mode “4” or the like in the light load state in which not all of the two systems need to be operated.

When the load state is bought into a lighter load state during the time when the chopper circuit 108 is driven with the chopper circuit 109 stopped, the operation mode is changed from the more “4” to the mode “5” so that the drive cycle (time period) T of the SW_Q1 of the chopper circuit 108 is brought to a drive circuit T1 which is longer than at present.

When the AC voltage detected value becomes 0 V or a value close to 0 V, the operations of the two chopper circuits 108 and 109 are stopped.

More specifically, in this example, the input voltage detecting unit 120 which detects the voltage of the input voltage inputted from the alternating power supply 101 is further provided, and the control circuit 115 changes the drive cycle (time period) T of the driven SW_Q1 to the time period T1 which is longer than before, or stops the drive itself of the SW_Q1 to thereby stop all of the switching operation when the input voltage detected y the AC input voltage detecting unit 120 becomes a value lower than the input voltage prescribed value (0 V or a value close to that).

Provision of the AC input voltage detecting unit 120 as described above can prevent as much as possible the efficiency from deteriorating during a light load in the mode “5” shown in FIG. 7 or when a device at the power supply destination is in a standby state (for example, in a state in which the backlight of the LCD display panel is turned off)

As described above, according to the converter power supply circuit of the second embodiment, the SW operation is not performed in a period when the AC input voltage is 0 V or close to that, in addition to the case of the above-described embodiment, because operation of all of the plurality of SW_Q1 and SW_Q2 is wasteful, so that the efficiency is not deteriorated also during a very low power consumption such as during a light load of the mode “5” or during standby.

Note that the present invention is not limited to the above embodiments, and the components may be changed in practical phase without departing from the scope of the invention. Further, a plurality of components disclosed in the above embodiments can be appropriately combined to configure various inventions.

For example, some components may be omitted from all of the components shown in the embodiments. Further, components in different embodiments may be combined as required.

Specifically, though the number of operation modes is six, that is, the mode “0” to the mode “5” in the above embodiments, the operation mode is further finely divided, whereby the output signal can be continuously and gradually (smoothly) changed.

Further, though variable control of the switching operation of the plurality of chopper circuits 108 and 109 to the variation in current of each unit has been mainly described in the operation flowchart of the above-described embodiment, the switching operation of the plurality of chopper circuits 108 and 109 may be variably controlled using the variation amount of the voltage detected by the voltage detecting unit 117.

Further, though the example in which the SW_Q1 of the chopper circuit 108 is always operated and the SW_Q2 of the chopper circuit 109 is stopped when the chopper circuit is operated in the mode 114 or “5” has been shown in the above embodiments, the element to be operated and the element to be stopped may be changed over, for example, every several minutes, every several hours, or several days in consideration of life of the elements.

In other words, the chopper circuit 108 on the operating side is not fixed, but operations/stops of the outputs of two systems are switched periodically and alternately, whereby the deviation of heat generation/current/part life can be evenly dispersed.

### Other Embodiments

The embodiments of the present invention are not limited to the above-describe embodiments, but can be extended or changed, and the extended and changed embodiments are also included in the technical scope of the present invention.

### Explanation of Codes

100 converter power supply circuit, 101 alternating power supply, 102 full-wave rectifier, 103 low-pass filter, 104 choke coil, 105, 106 capacitor, 107 chopper circuit group, 108, 109 chopper circuit, 112 smoothing capacitor, 113 load, 114 current detecting unit, 115 control circuit, 116 drive circuit, 117 voltage detecting unit, 118 memory, D1, D2 diode, L1, L2 choke coil, Q1, Q2 switching transistor (SW).

What is claimed is:

1. A converter power supply circuit, comprising:
a rectifier/smoothing unit which converts an alternating voltage inputted from a power source into a direct-current voltage;
a plurality of switching elements which are connected in parallel, to an output end of the rectifier/smoothing unit and switch by drive signals individually applied thereto to generate an output signal;
a smoothing capacitor which smoothes the output signal of the plurality of switching elements and supplies a smoothed signal to a load;
a switching current detecting unit which detects switching currents of the individual switching elements;
an output current detecting unit which detects a current of the output signal;
a memory in which threshold values for changing switching operations of the switching elements are set; and
a control unit which applies drive signals to the switching elements to continuously change an operation state thereof from a high power consumption state in which the plurality of switching elements are fully driven to a low power consumption state in which one of the plurality of switching elements is intermittently driven at a predetermined cycle, according to a comparison result of values of the currents detected by the output current detecting unit and the switching current detecting unit to the threshold values in the memory.

2. The converter power supply circuit according to claim 1,
wherein the control unit makes cycles for alternate operation of the plurality of switching elements the same and changes periods for drive of the switching elements according to the values of the detected currents, in the high power consumption state to a middle power consumption state.

3. The converter power supply circuit according to claim 1, further comprising:
an input voltage detecting unit which measures a voltage value of the alternating voltage inputted from the power source,
wherein the control unit makes a drive cycle of the driven switching element longer than before or stops the drive itself of the switching element when the voltage value measured by the input voltage detecting unit is 0 V or close to 0 V.

4. The converter power supply circuit according to claim 1,
wherein the control unit changes oscillation frequencies of the plurality of switching elements in a control process from the high power consumption state in which the plurality of switching elements are fully driven to the low power consumption state.

5. A converter power supply circuit driving method, comprising:
converting an alternating voltage into a direct-current voltage by a rectifier/smoothing unit;
individually applying drive signals to a plurality of switching elements which are connected in parallel, to an output end of the rectifier/smoothing unit to alternately switch the switching elements to generate an output signal;
smoothing the output signal of the plurality of switching elements by a smoothing capacitor and supplying a smoothed signal to a load;
detecting switching currents of the individual switching elements by a switching current detecting unit;
detecting a current of the output signal by an output current detecting unit; and
comparing values of the currents detected by the output current detecting unit and the switching current detecting unit to threshold values for changing switching operations stored in advance in a memory, and applying the drive signals to the switching elements to continuously change an operation state thereof from a high power consumption state in which the plurality of switching elements are fully driven to a low power consumption state in which one of the plurality of switching elements is intermittently driven at a predetermined cycle, according to a result of the comparison.

6. The converter power supply circuit driving method according to claim 5, further comprising:
making cycles for alternate operation of the plurality of switching elements the same and changing periods for drive of the switching elements according to the values of the detected currents, in the high power consumption state to a middle power consumption state.

7. The converter power supply circuit driving method according to claim 5, further comprising:
measuring a voltage value of the alternating voltage inputted from the power source; and
making a drive cycle of the driven switching element longer than before or stopping the drive itself of the switching element when the measured voltage value is 0 V or close to 0 V.

8. The converter power supply circuit driving method according to claim 5, further comprising:
changing oscillation frequencies of the plurality of switching elements in a control process from the high power consumption state in which the plurality of switching elements are fully driven to the low power consumption state.
